(19) United States
(12) Patent Application Publication
(10) Pub. No.: US 2016/0055823 A1
(43) Pub. Date: Feb. 25, 2016

(54) ELECTRONIC DEVICE FOR MULTI-WINDOW DISPLAY

(71) Applicant: Wistron Corporation, New Taipei City (TW)

(72) Inventors: Andy SW Feng, New Taipei City (TW); Hong-Yan Wu, New Taipei City (TW)

(21) Appl. No.: 14/675,544

(22) Filed: Mar. 31, 2015

(30) Foreign Application Priority Data
Aug. 25, 2014 (CN) 201410421959.2

(51) Int. Cl. G09G 5/10

(52) U.S. Cl. CPC G09G 5/10

(57) ABSTRACT

An electronic device includes a display device and a processing unit. The display device includes a display panel, a backlight module with a light source unit for providing light to the display panel, and a driver circuit. The light source unit has a plurality of light emitting regions each being independently controlled by the driver circuit. The processing unit may split a display screen of the display panel into a plurality of windows, and, in response to occurrence of a predefined event corresponding to at least one of the windows, controls the driver circuit to disable light emission of a part of the light emitting regions that corresponds to that window.

### CROSS-REFERENCE TO RELATED APPLICATION

This application claims priority to Chinese Application No. 201410421959.2, filed on Aug. 25, 2014, the entire disclosure of which is incorporated herein by reference.

### FIELD OF THE INVENTION

The invention relates to an electronic device, and more particularly to an electronic device capable of displaying multiple windows in a single display screen, thereby facilitating simultaneous execution of tasks associated with multiple applications.

### BACKGROUND OF THE INVENTION

Recently, sale of electronic devices such as mobile phones, tablet computers and notebook computers often places emphasis on provision of a large screen. In addition to greater power consumption attributed to the large screen, if the large screen can only be used to display a single display screen, for example, watching a video or browsing a single webpage, a user may need to switch among a plurality of application windows when the user desires/requires to, for example, browse other webpages, handle documents, or access an e-mail box, at the same time. Therefore, some split-screen application programs have been developed for the user to split their device screen into multiple windows each corresponding to an executed application. In such a manner, the user may simultaneously accomplish different tasks, such as browsing webpages, watching a movie, and handling documents, on different windows that are displayed in a single display screen.

However, during the multi-window operation, some of the windows may be non-operated or non-browsed by the user for a long period of time. These non-operated windows that are being displayed consume power, thereby resulting in inefficient power saving for the electronic device.

### SUMMARY OF THE INVENTION

Therefore, an object of the present invention is to provide an electronic device that provides a multi-window display function, and that may appropriately disable light emission of a part of a light source corresponding to one or some of the windows displayed thereby.

According to the present invention, an electronic device is adapted for multi-window display, and comprises:

a display device including:
a display panel;
a backlight module including a light source unit for providing of light to said display panel, said light source unit having a plurality of light emitting regions; and
a driver circuit configured to control light emission of each of the light emitting regions of the light source unit independently; and

a processing unit configured to operate in a multi-window display mode, in which the processing unit splits a display screen of the display panel into a plurality of windows, and, in response to occurrence of a predefined event corresponding to at least one of the windows, controls the driver circuit to disable light emission of a part of the light emitting regions that corresponds to the at least one of the windows.

### BRIEF DESCRIPTION OF THE DRAWINGS

Other features and advantages of the present invention will become apparent in the following detailed description of embodiments with reference to the accompanying drawings, of which:

FIG. 1 is a schematic diagram illustrating a first embodiment of the electronic device for multi-window display according to the present disclosure;

FIG. 2 is a schematic diagram illustrating an implementation of the first embodiment that has a linear light source disposed at a bottom side of a display panel with display function of a part that corresponds to a left window being disabled;

FIG. 3 is a schematic diagram illustrating another implementation of the first embodiment that has the linear light source disposed at a left side of the display panel with display function of a part that corresponds to a lower window being disabled;

FIG. 4 is a schematic diagram illustrating a second embodiment of the electronic device for multi-window display according to the present disclosure, wherein a part of a light source that corresponds to an upper-right window is in a disabled state;

FIG. 5 is a schematic diagram illustrating a third embodiment of the electronic device for multi-window display according to the present disclosure, wherein a part of a light source that corresponds to a right window is in a disabled state;

FIG. 6 is a schematic diagram illustrating a fourth embodiment of the electronic device for multi-window display according to the present disclosure, and illustrating a linear light source that is composed of light emitting diodes and that has a disabled part corresponding to a lower-right window and a lower-left window;

FIG. 7 is a schematic diagram illustrating another implementation of the third embodiment that has the linear light sources arranged behind the display panel in parallel along a vertical direction, wherein a part of the linear light sources that corresponds to a lower window is in a disabled state; and

FIG. 8 is a schematic diagram to illustrate that the linear light sources shown in FIG. 7 may be composed of light emitting diodes, wherein a part of the linear light sources that corresponds to an upper-right window is in a disabled state.

### DETAILED DESCRIPTION OF THE EMBODIMENTS

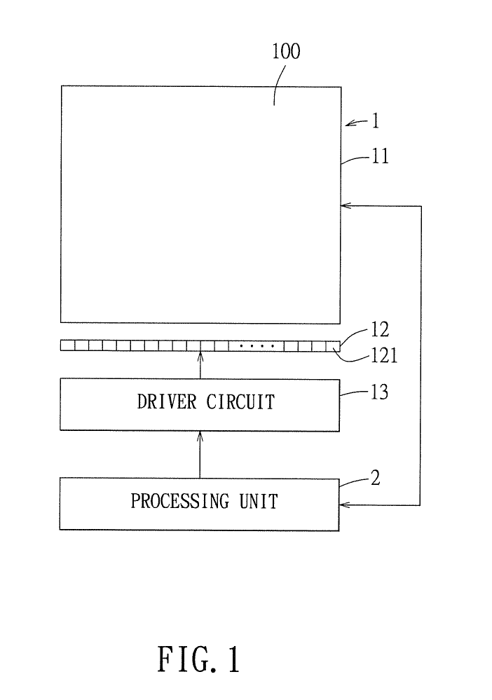

Referring to FIG. 1, the first embodiment of the electronic device adapted for multi-window display according to this disclosure is shown to include a flat panel display device 1 and a processing unit 2 (e.g., a central processor). The display device 1 of this embodiment primarily includes a display panel 11, an edge type backlight module including a first linear light source 12, and a driver circuit 13. The first linear light source 12 has a plurality of light emitting regions each being independently controllable for light emission, and is disposed at one side of the display panel 11, for example, a bottom/lower side (or a top/upper side) of the display panel 11. The driver circuit 13 is configured to control light emission of each of the light emitting regions of the first linear light source 12 independently. The first linear light source 12 is configured to emit light to a light guide structure of the edge type backlight module. The light guide structure guides the light toward the display panel 11, to thereby serve as a light source of the entire display panel 11. Since techniques for the light guide structure should be well-known to persons skilled in the art, details thereof are omitted herein for the sake of brevity. The processing unit 2 is capable of operating in a multi-window display mode, in which a display screen 100 of the display device 1 is split into a plurality of windows. The processing unit 2 may, in response to occurrence of a predefined event corresponding to at least one of the windows thus split, control the driver circuit 13 to disable light emission of a part of the light emitting regions that corresponds to said at least one of the windows.

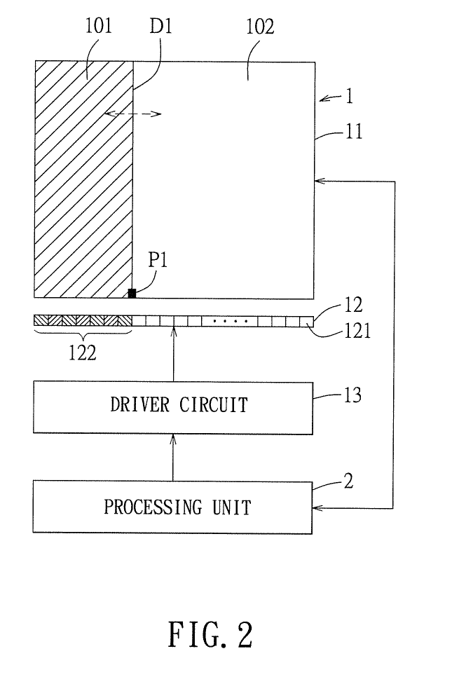

In detail, referring to FIG. 2, when a split-screen application program is executed, the processing unit 2 receives a split-screen command resulting from user operation through the split-screen application program, to thereby operate in the multi-window display mode, i.e., to split the display screen 100 into a plurality of windows. For example, a user may generate the split-screen command via the split-screen application program, to enable or disable the split-screen function, or to set a number of windows to be split. In one embodiment, the split-screen command is set to cause the processing unit 2 to initially split the display screen 100 into a left window 101 and a right window 102 that are disposed in parallel along a horizontal direction. At this time, the split-screen application program may cause the electronic device to display on the display screen 100 a vertical border line D1 between the left window 101 and the right window 102. When the display panel 11 is capable of touch control, the user may horizontally move the vertical border line D1 to adjust sizes of the left window 101 and the right window 102 by touch operation on an operation point P1 that is disposed at an end of the vertical border line D1. If the display panel 11 is not configured for touch control, the user may use a cursor to drag the operation point P1, to thereby horizontally move the vertical border line D1 for adjusting the sizes of the left window 101 and the right window 102.

The split-screen application program may generate the split-screen command that is provided to the processing unit 2 according to a final position of the vertical border line D1, and the processing unit 2 splits the display screen 100 into the left window 101 and the right window 102 according to the split-screen command. Note that this embodiment is not limited to two split windows, and the display screen 100 may be split into more than two windows as required if the size of the display panel 11 is sufficiently large. In such a manner, different applications may be executed respectively in the left window 101 and the right window 102 for provision of different information to the user at the same time, and the user may perform operations on either the left window 101 or the right window 102 without conducting window switching operations.

In this embodiment, the first linear light source 12 is composed of a plurality of light emitting diodes 121 arranged in a straight line, and the driver circuit 13 is configured to independently enable or disable light emission of each of the light emitting diodes 121.

In a case of the display panel 11 being capable of touch control (i.e., a touch control display panel), the predefined event that causes the processing unit 2 to perform an energy-saving operation (i.e., disabling light emission of apart of the light emitting regions of the light source) may refer to, for example, the processing unit 2 detecting a touch operation on a specific position (e.g., a position that shows an energy-saving symbol (not shown)) of one of the two windows (e.g., the left window 101), or the processing unit 2 detecting a predefined user gesture (e.g., pressing and holding for a period of time, a quick double-tap, etc.) that indicates the energy-saving operation is to be performed on a part of the touch display panel that corresponds to, for example, the left window 101. In another example, the processing unit 2 may actively detect both of the left and right windows 101, 102, and performs the energy-saving operation upon detecting that a time length of non-operation or non-update for, as an example, the left window 101, has reached a predetermined time length (e.g., 3 minutes or 5 minutes).

In such a manner, the processing unit 2 controls the driver circuit 13 to disable light emission of the light emitting region 122 that corresponds to the left window 101 in response to occurrence of the predefined event. That is, light emission of the light emitting diodes 121 disposed in the light emitting region 122 is disabled, to thereby reduce power consumption of the display device 1 when the left window 101 is currently not in use.

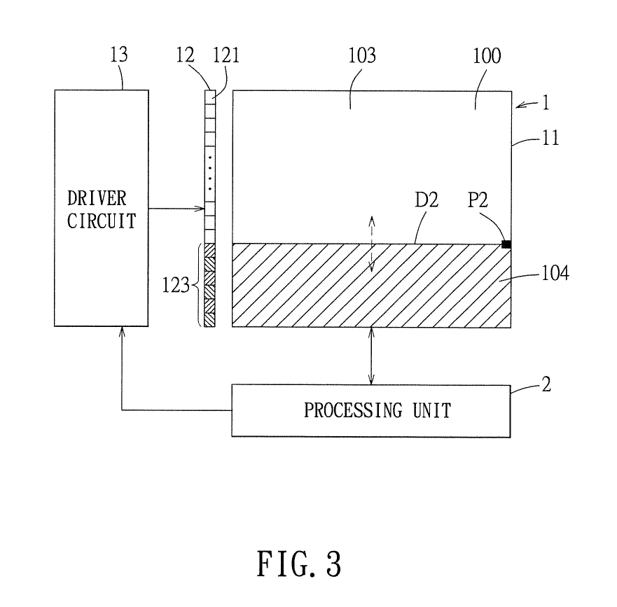

Referring to FIG. 3 for another implementation of this embodiment, the first linear light source 12 is disposed at a left side (or a right side) of the display panel 11. Similarly, corresponding to placement of the first linear light source 12, the processing unit 2 may, upon receipt of the split-screen command generated by the split-screen application program, split the display screen 100 into an upper window 103 and a lower window 104 disposed in parallel along a vertical direction. The split-screen application program may cause the electronic device to display on the display screen 100 a horizontal border line D2 between the upper window 103 and the lower window 104. In the case of the display panel 11 being capable of touch control, the user may vertically move the horizontal border line D2 to adjust sizes of the upper window 103 and the lower window 104 by touch or cursor operation on an operation point P2 that is disposed at an end of the horizontal border line D2.

Similarly, the predefined event that causes the processing unit 2 to perform the energy-saving operation may be, for example, the processing unit 2 detecting a touch operation on a specific position of the lower window 104, the processing unit 2 detecting a predefined user gesture on a part of the touch display panel that corresponds to the lower window 104, or the processing unit 2 detecting that a time length of non-operation or non-update for the lower window 104 has reached a predetermined time length. Then, the processing unit 2 controls the driver circuit 13 to disable light emission of the light emitting region 123 of the first linear light source 12 that corresponds to the lower window 104, to thereby reduce power consumption of the display device 1 when the lower window 104 is currently not in use.

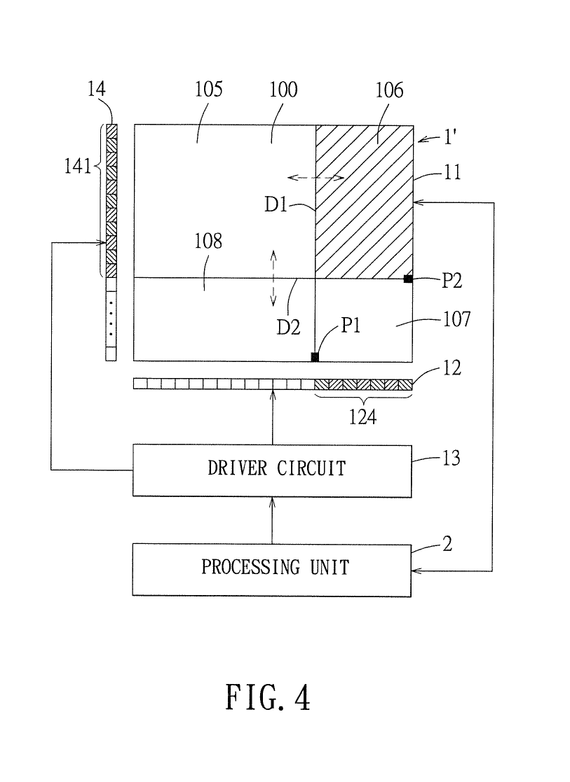

Referring to FIG. 4, the second embodiment of the electronic device adapted for multi-window display is shown to differ from the first embodiment in that: the edge type backlight module of the flat panel display device 1′ includes a first linear light source 12 disposed at the bottom/lower side (or the top/upper side) of the display panel 11, and a second linear light source 14 disposed at the left side (or the right side) of the display panel 11. Each of the first and second linear light sources 12, 14 has a plurality of light emitting regions. The driver circuit 13 is controllable by the processing unit 2 to control light emission of each of the light emitting regions of the first linear light source 12 independently, and to control light emission of each of the light emitting regions of the second linear light source 14 independently.

In this embodiment, the processing unit 2 may, upon receipt of the split-screen command generated by the split-screen application program, split the display screen 100 into an upper-left window 105, an upper-right window 106, a lower-right window 107 and a lower-left window 108. The split-screen application program may cause the electronic device to display on the display screen 100 the vertical border line D1 and the horizontal border line D2. The user may move the vertical border line D1 and the horizontal border line D2 to adjust sizes of the windows 105-108 as required by touch or cursor operation on the operation point P1 of the vertical border line D1 and the operation point P2 of the horizontal border line D2.

Similarly, the processing unit 2 may, in response to occurrence of the predefined event corresponding to the windows 105-108, control the driver circuit 13 to disable light emission of a part of the light emitting regions of the first linear light source 12 and the second linear light source 14 that corresponds to the window(s) at which the predefined event has occurred. In the case of the display panel 11 being capable of touch control, the predefined event that causes the processing unit 2 to perform the energy-saving operation may be, for example, the processing unit 2 detecting a touch operation on a specific position of the upper-right window 106, the processing unit 2 detecting a predefined user gesture on a part of the touch display panel that corresponds to the upper-right window 106, or the processing unit 2 actively detecting operations of the windows 105-108, and detecting that a time length of non-operation or non-update for the upper-right window 106 has reached a predetermined time length. Then, the processing unit 2 controls the driver circuit 13 to disable light emission of the light emitting region 124 of the first linear light source 12 that corresponds to the upper-right window 106, and to disable light emission of the light emitting region 141 of the second linear light source 14 that corresponds to the upper-right window 106, to thereby reduce power consumption of the display device 1 when the upper-right window 106 is temporarily not in use. In such a manner, the processing unit 2 may disable display of at least one of the windows 105-108 at an appropriate time.

In this embodiment, when the processing unit 2 detects occurrence of operation/update for the windows whose corresponding part of the light emitting regions was disabled, the processing unit 2 may control the driver circuit 13 to actuate light emission of the part of the light emitting regions that corresponds to those windows. As an example, when the processing unit 2 detects that the aforementioned window 101, 104 or 106 is operated again (e.g., a cursor is moved into the window 101, 104 or 106, a user gesture that is preset to exit the energy-saving state, such as pressing and holding for a period of time or a double-tap is performed in the window 101, 104 or 106, or information of the window 101, 104 or 106 is updated), the processing unit 2 may control the driver circuit 13 to actuate light emission of the part of the light emitting regions that corresponds to the window 101, 104 or 106.

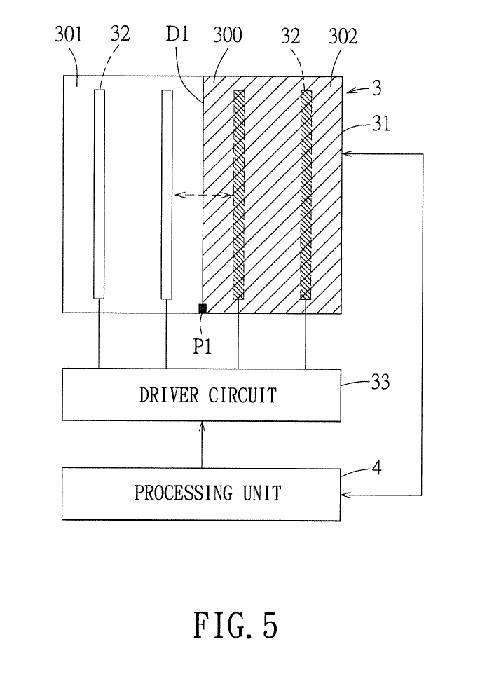

Referring to FIG. 5, the third embodiment of the electronic device for multi-window display according to the present disclosure is shown to include a flat panel display device 3 and a processing unit 4. The display device 3 includes a display panel 31, a direct type backlight module that is disposed behind the display panel 31, and a driver circuit 33. The direct type backlight module of this embodiment primarily includes a planar light source and a light guide structure that guides the light toward the display panel 31, to thereby serve as a light source of the entire display panel 31. Since techniques for the light guide structure should be well-known to persons skilled in the art, details thereof are omitted herein for the sake of brevity.

In this embodiment, the planar light source includes a plurality of linear light sources 32 that are disposed in parallel along a horizontal direction, e.g., four cold cathode fluorescent lamps (CCFL) or electroluminescence (EL) strips disposed behind the display panel 31 in parallel along the horizontal direction, as shown in FIG. 5. The driver circuit 33 is configured to independently drive light emission of each of the linear light sources 32. The processing unit 4 is configured to, corresponding to placement of the linear light sources 32, operate in a multi-window display mode to split a display screen 300 of the display panel 31 into a plurality of windows, and to, in response to occurrence of a predefined event corresponding to at least one of the windows, control the driver circuit 33 to disable light emission of at least one of the linear light sources 32 that corresponds to said at least one of the windows.

In this embodiment, the processing unit 4 is configured to split the display screen 300 into a left window 301 and a right window 302 according to a split-screen command generated by a split-screen application program. Similar to what was described in the first embodiment, the split-screen application program may cause the electronic device to display on the display screen 300 a vertical border line D1. When the display panel 31 is capable of touch control, the user may horizontally move the vertical border line D1 to adjust sizes of the left window 301 and the right window 302 by touch operation on an operation point P1 that is disposed at an end of the vertical border line D1.

Similar to what was described in the first embodiment, the predefined event that causes the processing unit 4 to perform the energy-saving operation may be, for example, the processing unit 4 detecting a touch operation on a specific position of the right window 302, the processing unit 4 detecting a predefined user gesture on a part of the touch display panel that corresponds to the right window 302, or the processing unit 4 actively detecting both of the left and right windows 301, 302, and detecting that a time length of non-operation or non-update for the right window 302 has reached a predetermined time length. Then, the processing unit 4 controls the driver circuit 33 to disable light emission of two of the linear light sources 32 that correspond to the right window 302 (i.e., the linear light sources 32 that are disposed behind the right window 302), to thereby reduce power consumption of the display device 3 when the right window 302 is currently not in use.

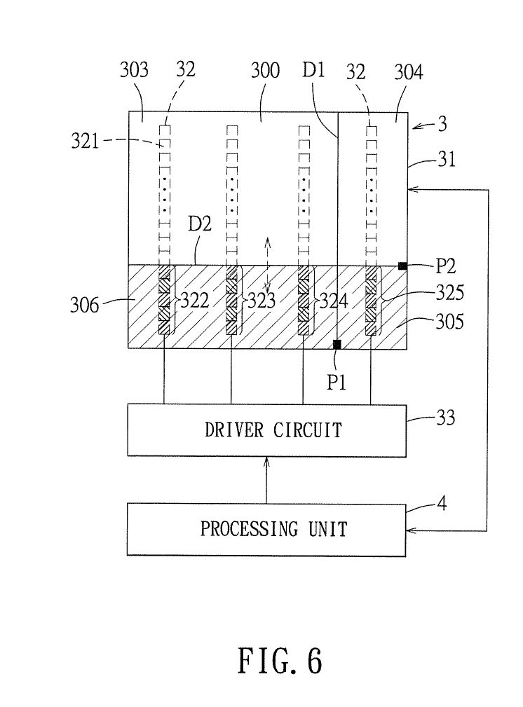

Referring to FIG. 6, the fourth embodiment of the electronic device for multi-window display according to the present disclosure is shown to differ from the third embodiment in that each of the linear light sources 32 is composed of a plurality of light emitting diodes 321 arranged in a straight line, and that the driver circuit 33 is configured to independently control (i.e., enable/disable) light emission of each of the light emitting diodes 321. By virtue of such a structure, the processing unit 4 may not only split the display screen 300 into left and right windows (see FIG. 5), but may also split the display screen 300 into upper and lower windows, or into four windows 303-306 that are respectively disposed at an upper-left side, an upper-right side, a lower-right side and a lower-left side of the display screen 300. Similar to what was described in the second embodiment, the split-screen application program may cause the electronic device to display on the display screen 300 a vertical border line D1 and a horizontal border line D2. The user may move the vertical border line D1 and/or the horizontal border line D2 to adjust a size of each of the windows 303-306 by touch and/or cursor operation on an operation point P1 of the vertical border line D1 and an operation point P2 of the horizontal border line D2. In this embodiment, when the vertical border line D1 is moved to a leftmost side or a rightmost side of the display screen 300, the display screen 300 is split into upper and lower windows only, and when the horizontal border line D2 is moved to a top side or a bottom side of the display screen 300, the display screen 300 is split into left and right windows only.

In addition, the processing unit 4 further performs the energy-saving operation according to, for example, the aforesaid operation states of the windows 303-306, to control the driver circuit 33 to disable light emission of one or some of the linear light sources 32 corresponding to the windows at which the predefined event has occurred. In a case of the display panel 31 being capable of touch control, the predefined event that causes the processing unit 4 to perform the energy-saving operation may be, for example, the processing unit 4 detecting a touch operation on a specific position of the lower-right window 305, the processing unit 4 detecting a predefined user gesture on a part of the touch display panel that corresponds to the lower-right window 305, or the processing unit 4 actively detecting the windows 303-306, and detecting that a time length of non-operation or non-update for the lower-right window 305 has reached a predetermined time length. Then, the processing unit 4 controls the driver circuit 33 to disable light emission of a part 325 of one of the linear light sources 32 that corresponds to the lower-right window 305, to thereby reduce power consumption of the display device 3 when the lower-right window 305 is currently not in use. As shown in FIG. 6, the processing unit 4 may simultaneously disable light emission of parts 322, 323, 324, 325 of the linear light sources 32 that correspond to two (or more) windows 305, 306.

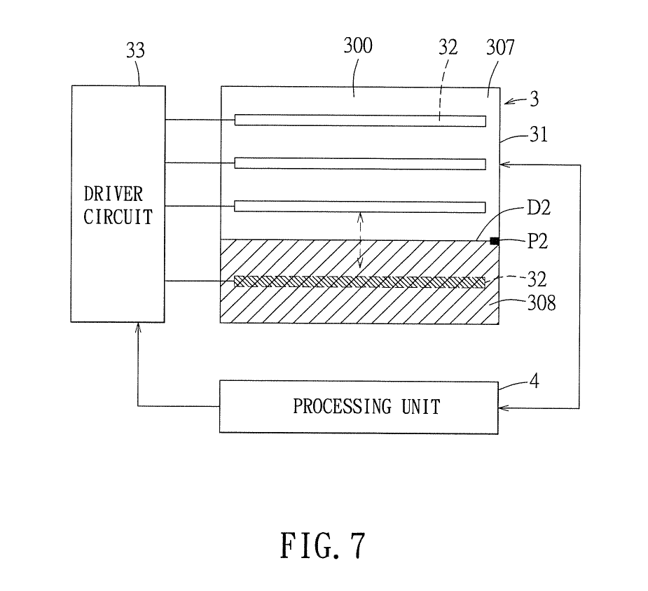

Referring to FIG. 7, the linear light sources 32 of the third embodiment may be disposed in parallel along a vertical direction behind the display panel 31 in another implementation. Similarly, corresponding to placement of the linear light sources 32, the processing unit 4 splits the display screen 300 into an upper window 307 and a lower window 308 disposed in parallel along the vertical direction. The user may move the horizontal border line D2 that is generated by the split-screen application program to adjust sizes of the upper window 307 and the lower window 308 by touch operation on the operation point P2 disposed at an end of the horizontal border line D2. The processing unit 4 is configured to, in response to occurrence of the predefined event corresponding to the upper window 307 or the lower window 308, control the driver circuit 33 to disable light emission of the corresponding one(s) of the linear light sources 32.

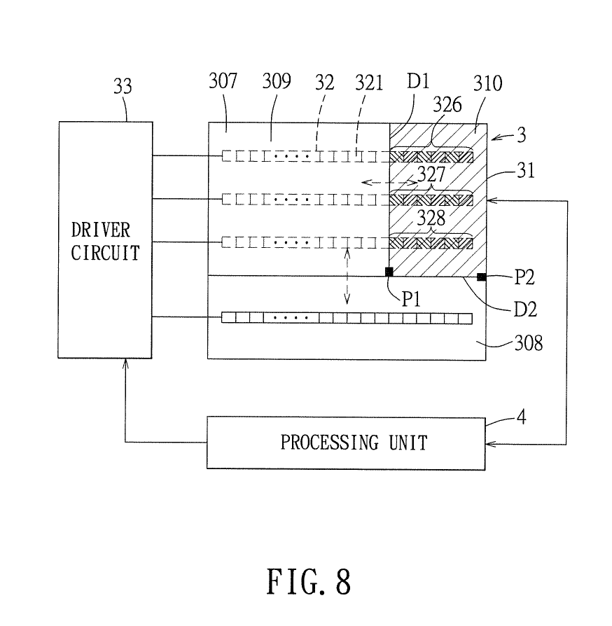

Referring to FIG. 8, each of the aforementioned linear light sources 32 that are disposed in parallel along the vertical direction may be composed of a plurality of light emitting diodes 321 that are arranged in a straight line. The driver circuit 33 is capable of independently controlling light emission of each of the light emitting diodes 321. According to the split-screen command, the processing unit 4 may not only split the display screen 300 into two or four windows as shown in FIGS. 5, 6 and 7, but may also split the display screen 30 into three windows, as shown in FIG. 8. For example, the display screen 300 may be first split into upper and lower windows 307, 308, and then the upper window 307 (or the lower window 308) may be further split into windows 309, 310 that are respectively disposed at left and right sides of the upper window 307. In this situation, the split-screen application program may display on the display screen 300 a horizontal border line D2 for adjusting sizes of the windows 307, 308, and display on the upper window 307 a vertical border line D1 for adjusting sizes of the windows 309, 310.

In the same manner, the processing unit 4 may, in response to occurrence of a predefined event, control the driver circuit 33 to disable light emission of one or some of the linear light sources 32 corresponding to the windows at which the predefined event has occurred. In a case of the display panel 31 being capable of touch control, the predefined event that causes the processing unit 4 to perform the energy-saving operation may be, for example, the processing unit 4 detecting a touch operation on a specific position of the upper-right window 310, the processing unit 4 detecting a predefined user gesture on a part of the touch display panel that corresponds to the upper-right window 310, or the processing unit 4 detecting that a time length of non-operation or non-update for the upper-right window 310 has reached a predetermined time length. Then, the processing unit 4 controls the driver circuit 33 to disable light emission of parts 326, 327, 328 of three of the linear light sources 32 that correspond to the upper-right window 310, to thereby reduce power consumption of the display device 3 when the upper-right window 310 is currently not in use.

Moreover, the aforesaid planar light source may be composed of a plurality of EL sheets arranged in an array, and the driver circuit 33 independently controls light emission of each of the EL sheets. Accordingly, the processing unit 4 may disable light emission of one or some of the EL sheets that correspond to a certain window, such that the planar light source emits light regionally, thereby achieving energy-saving.

It should be noted that the electronic device for multi-window display in the abovementioned embodiments mainly refer to portable electronic devices which are powered primarily using batteries, such as mobile phones, tablet computers or notebook computers, but the present invention should not be limited in this respect. The present disclosure may also apply to desktop computers, flat panel digital televisions, flat display apparatuses that may serve as outdoor or indoor advertisement billboards, etc.

In summary, the processing unit of the present disclosure detects operation states of different windows of the display screen, and controls the driver circuit to disable light emission of a part of the light source (backlight source) that corresponds to a certain window at an appropriate time, thereby reducing power consumption of the display device.

While the present invention has been described in connection with what are considered the most practical embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An electronic device adapted for multi-window display, said electronic device comprising:
a display device including:
a display panel;
a backlight module including a light source unit for providing light to said display panel, said light source unit having a plurality of light emitting regions; and
a driver circuit configured to control light emission of each of said light emitting regions of said light source unit independently; and
a processing unit configured to operate in a multi-window display mode, in which said processing unit splits a display screen of said display panel into a plurality of windows, and, in response to occurrence of a predefined event corresponding to at least one of said windows, controls said driver circuit to disable light emission of a part of said light emitting regions that corresponds to said at least one of said windows.

2. The electronic device according to claim 1, wherein:
said light source unit includes a linear light source disposed at one of an upper side and a lower side of said display panel;
said processing unit is configured to operate in the multi-window display mode in response to receipt of a split-screen command; and
in the multi-window display mode, said processing unit splits said display screen into at least a left window and a right window that are disposed in parallel along a horizontal direction according to the split-screen command, and, in response to occurrence of the predefined event corresponding to one of said left window and said right window, controls said driver circuit to disable light emission of a part of said linear light source that corresponds to said one of said left window and said right window.

3. The electronic device according to claim 1, wherein:
said light source unit includes a linear light source disposed at one of a left side and a right side of said display panel;
said processing unit is configured to operate in the multi-window display mode in response to receipt of a split-screen command; and
in the multi-window display mode, said processing unit splits said display screen into at least an upper window and a lower window that are disposed in parallel along a vertical direction according to the split-screen command, and, in response to occurrence of the predefined event corresponding to one of said upper window and said lower window, controls said driver circuit to disable light emission of a part of said linear light source that corresponds to said one of said upper window and said lower window.

4. The electronic device according to claim 1, wherein said light source unit is a linear light source including a plurality of light emitting diodes arranged in a straight line, and said driver circuit is configured to disable a part of said light emitting diodes that are disposed on said part of said light emitting regions of said that corresponds to said at least one of said windows.

5. The electronic device according to claim 1, wherein:
said light source unit includes a first linear light source disposed at one of a left side and a right side of said display panel, and a second linear light source disposed at one of an upper side and a lower side of said display panel;
said processing unit is configured to operate in the multi-window display mode in response to receipt of a split-screen command; and
in the multi-window display mode, said processing unit splits said display screen into at least four windows respectively disposed on an upper-left part, an upper-right part, a lower-left part and a lower right part of said display screen according to the split-screen command, and, in response to occurrence of the predefined event corresponding to at least one of said four windows, controls said driver circuit to disable light emission of a part of said first linear light source and a part of said second linear light source that correspond to said at least one of said four windows.

6. The electronic device according to claim 1, wherein said display panel is configured for touch control, and the predefined event is one of a touch operation on a specific position of said at least one of said windows, and a predefined gesture applied on said at least one of said windows.

7. The electronic device according to claim 1, wherein said processing unit is configured to detect a time length of one of non-operation and non-update for each of said windows, and the predefined event is that the time length detected for said at least one of said windows has reached a predetermined time length.

8. The electronic device according to claim 1, wherein, when said processing unit operates in the multi-window display mode, said processing unit controls said display panel to display a border line between adjacent ones of said windows, said border line being movable on said display screen upon user operation, and defining a size of a respective one of said windows associated therewith.

9. The electronic device according to claim 1, wherein said processing unit is configured to, upon detecting occurrence of one of operation and update for said at least one of said windows, control said driver circuit to actuate light emission of said part of said light emitting regions that corresponds to said at least one of said windows.

10. The electronic device according to claim 1, wherein:
said light source unit includes a planar light source disposed behind said display panel, said planar light source including a plurality of linear light sources that are disposed in parallel along a horizontal direction;
said processing unit is configured to operate in the multi-window display mode in response to receipt of a split-screen command; and
in the multi-window display mode, said processing unit splits said display screen into at least a left window and a right window that are disposed in parallel along the horizontal direction according to the split-screen command, and, in response to occurrence of the predefined event corresponding to one of said left window and said right window, controls said driver circuit to disable light emission of at least one of said linear light sources that corresponds to said one of said left window and said right window.

11. The electronic device according to claim 1, wherein:
said light source unit includes a planar light source disposed behind said display panel, said planar light source including a plurality of linear light sources that are disposed in parallel along a horizontal direction, each of said linear light sources including a plurality of light emitting diodes arranged in a straight line;
said processing unit is configured to operate in the multi-window display mode in response to receipt of a split-screen command; and
in the multi-window display mode, said processing unit splits said display screen into at least an upper window and a lower window that are disposed in parallel along a vertical direction according to the split-screen command, and, in response to occurrence of the predefined event corresponding to one of said upper window and said lower window, controls said driver circuit to disable light emission of a part of said light emitting diodes that corresponds to said one of said upper window and said lower window.

12. The electronic device according to claim 1, wherein:
said light source unit includes a planar light source disposed behind said display panel, said planar light source including a plurality of linear light sources that are disposed in parallel along a vertical direction;
said processing unit is configured to operate in the multi-window display mode in response to receipt of a split-screen command; and
in the multi-window display mode, said processing unit splits said display screen into at least an upper window and a lower window that are disposed in parallel along the vertical direction according to the split-screen command, and, in response to occurrence of the predefined event corresponding to one of said upper window and said lower window, controls said driver circuit to disable light emission of at least one of said linear light sources that corresponds to said one of said upper window and said lower window.

13. The electronic device according to claim 1, wherein:
said light source unit includes a planar light source disposed behind said display panel, said planar light source including a plurality of linear light sources that are disposed in parallel along a vertical direction, each of said linear light sources including a plurality of light emitting diodes arranged in a straight line;
said processing unit is configured to operate in the multi-window display mode in response to receipt of a split-screen command; and
in the multi-window display mode, said processing unit splits said display screen into at least a left window and a right window that are disposed in parallel along a horizontal direction according to the split-screen command, and, in response to occurrence of the predefined event corresponding to one of said left window and said right window, controls said driver circuit to disable light emission of a part of said light emitting diodes that corresponds to said one of said left window and said right window.
